(19) United States
(12) Patent Application Publication
(10) Pub. No.: US 2014/0214607 A1
(43) Pub. Date: Jul. 31, 2014

(54) GLOBAL CURRENCY OF CREDIBILITY FOR CROWDSOURCING

(71) Applicant: MICROSOFT CORPORATION, Redmond, WA (US)

(72) Inventors: Gabriella Kazai, Bishop's Stortford (GB); Samuel Gavin Smyth, Cambridge (GB); Natasa Milic-Frayling, Cambridge (GB)

(73) Assignee: Microsoft Corporation, Redmond, WA (US)

(21) Appl. No.: 13/752,431

(22) Filed: Jan. 29, 2013

(51) Int. Cl. G06Q 30/06

(52) U.S. Cl. CPC G06Q 30/0609
USPC 705/26.35

(57) ABSTRACT

A global currency for crowdsourcing which comprises stored credibility values for every buyer (of human intelligence) and seller (of human intelligence) in a crowdsourcing system is described, creating an ecosystem where buyers and sellers are interdependent on each other. This dependence is the property of a global currency of credibility, where a buyer's credibility is a function of the credibility of the sellers who engaged with HITs published by the buyer, while the credibility of a seller is a function of the credibility scores associated with the HITs, which in turn is dependent on the buyer's credibility. The credibility scores are updated with every HIT completion and propagated through a network that connects HITs with buyers, sellers and platforms, as well as sellers with other sellers and buyers with other buyers. Buyers and sellers can bid, auction and refer HITs as a function of their credibility scores.

### BACKGROUND

Crowdsourcing is a tool that Human Computation (HC) systems may use to distribute work to be performed by individuals, where HC is a task (or computation) that is performed by a human and typically relates to those jobs that humans are better at doing than computers, such as image or relevance labeling, or building a knowledge base. Work which needs to be completed is typically divided into small tasks (known as Human Intelligence Tasks, HITs) which are then exposed to the crowd. A person within the crowd can decide to complete a HIT and will typically select HITs to complete based on the pay (if any) and characteristics of particular tasks. Once the work is complete, the entity that generated the task reviews the work and accepts or rejects it and on the basis of this review the person that completed the work is paid or not. There may be other instances where there is no pay and the reward is entertainment or other forms of self-fulfillment, such as altruism.

A crowdsourcing platform is an online system that connects those who have HITs that they want completed (who may be referred to as ‘requesters’) and people who perform the HITs (who may be referred to as ‘workers’). A platform allows requesters to publish HITs and workers to view available HITs and complete them. In some platforms, workers can preview HITs before accepting to work on them.

In existing crowdsourcing platforms, requesters have little or no capability to select the workers that should work on any task. Unlike conventional employment where workers have a contract of employment with an employer, in crowdsourcing, the workers are usually anonymous and there is no contract between a requester and a worker. In addition, the workforce in a crowdsourcing platform is typically diverse and dispersed. Some crowdsourcing platforms allow requesters to target workers with certain properties, e.g. workers whose HIT approval rate is above a given threshold specified by the requester, workers who achieved a “master” status or workers in a given country or region (such as those registered as living in the US). However, it is not generally possible for a requester to target workers that are skilled, reliable and trustful, as a worker can increase their HIT approval rate (i.e. the proportion of their HITs which are approved by the requester) by completing relatively easy tasks.

The embodiments described below are not limited to implementations which solve any or all of the disadvantages of known crowdsourcing platforms.

### SUMMARY

The following presents a simplified summary of the disclosure in order to provide a basic understanding to the reader. This summary is not an extensive overview of the disclosure and it does not identify key/critical elements or delineate the scope of the specification. Its sole purpose is to present a selection of concepts disclosed herein in a simplified form as a prelude to the more detailed description that is presented later.

A global currency for crowdsourcing which comprises stored credibility values for every buyer (of human intelligence) and seller (of human intelligence) in a crowdsourcing system is described, creating an ecosystem where buyers and sellers are interdependent on each other. This dependence is the property of a global currency of credibility, where a buyer's credibility is a function of the credibility of the sellers who engaged with HITs published by the buyer, while the credibility of a seller is a function of the credibility scores associated with the HITs, which in turn is dependent on the buyer's credibility. The credibility scores are updated with every HIT completion and propagated through a network that connects HITs with buyers, sellers and platforms, as well as sellers with other sellers and buyers with other buyers. Buyers and sellers can bid, auction and refer HITs as a function of their credibility scores.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of an example crowdsourcing system which comprises a management entity;

FIG. 2 is a schematic diagram of the management entity shown in FIG. 1;

FIG. 3 is a flow diagram of an example method of operation of a management entity as shown in FIG. 2;

FIG. 4 is a diagram of an example network of a HIT;

FIG. 5 is a schematic diagram of another example crowdsourcing system which comprises a management entity;

FIG. 6 is a schematic diagram of a further example crowdsourcing system which comprises a management entity;

FIG. 7 is a flow diagram of an example method of controlling the activity of a seller;

FIG. 8 is a flow diagram of an example method of updating credibility values;

FIG. 9 is a diagram of an example network of connections within a crowdsourcing system; and

FIG. 10 illustrates an exemplary computing-based device in which embodiments of the methods described herein may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

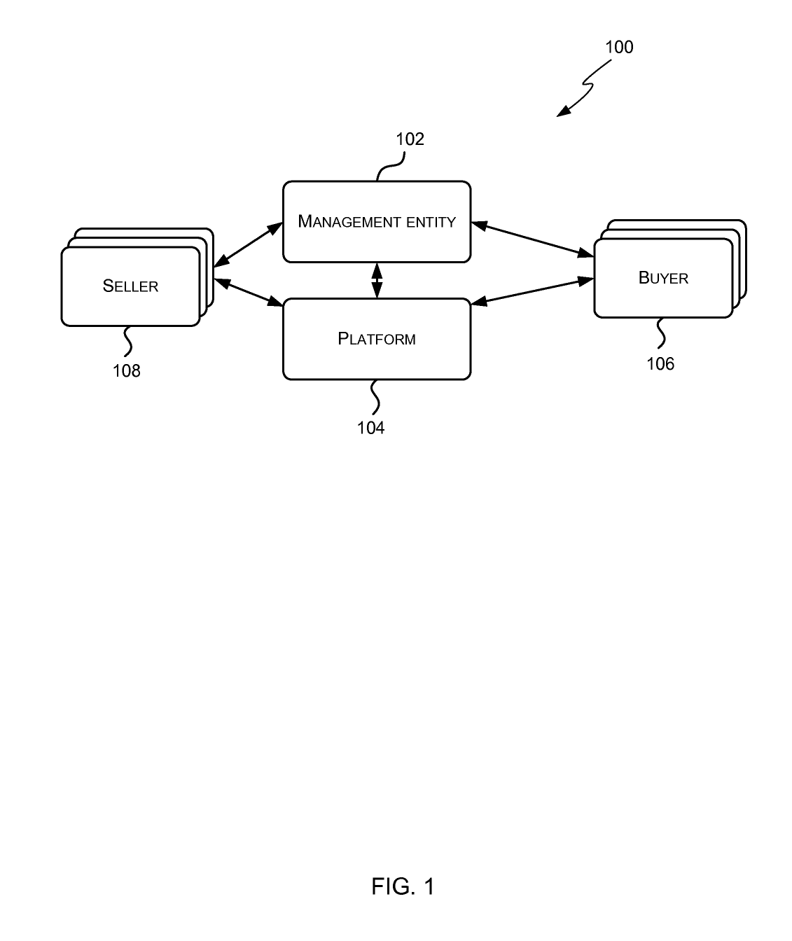

FIG. 1 is a schematic diagram of a crowdsourcing system 100 (or labor trading environment) which comprises a management entity 102 which may be referred to as a ‘market layer’ or ‘market’ and acts as an information broker among components of the system 100. The system 100 further comprises a crowdsourcing platform 104 and a number of buyers 106 and sellers 108. The buyers 106 use the system 100 to buy human intelligence (through the publishing of HITs) and may be requesters themselves or representatives, agents or groups of requesters. The sellers 108 use the system 100 to sell human intelligence (through the completion of HITs) and may be workers themselves or representatives, agents or groups of workers. Agents (for buyers or sellers) may be either human or automation service based entities.

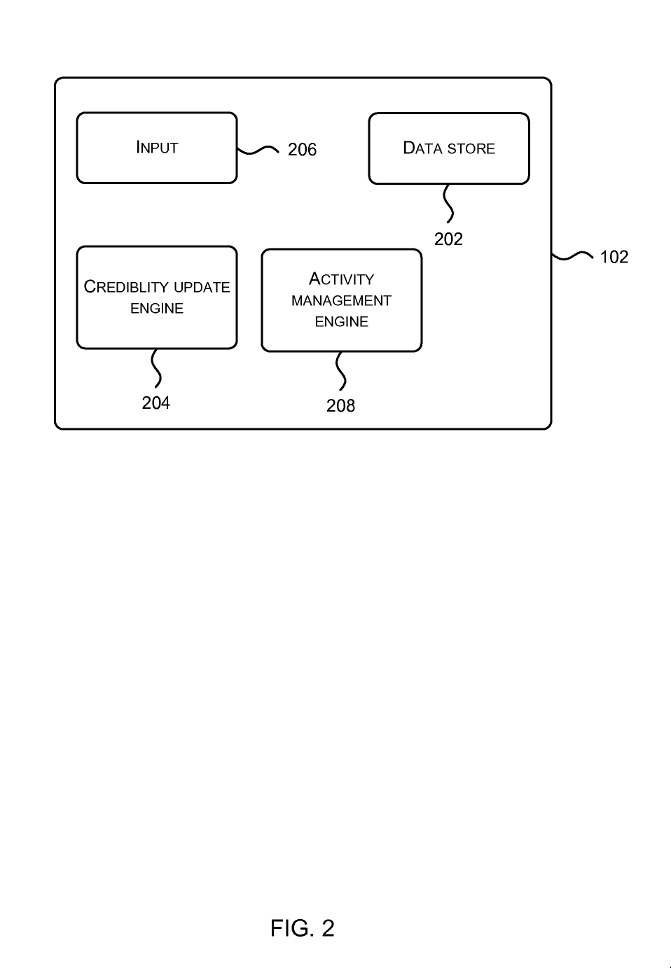

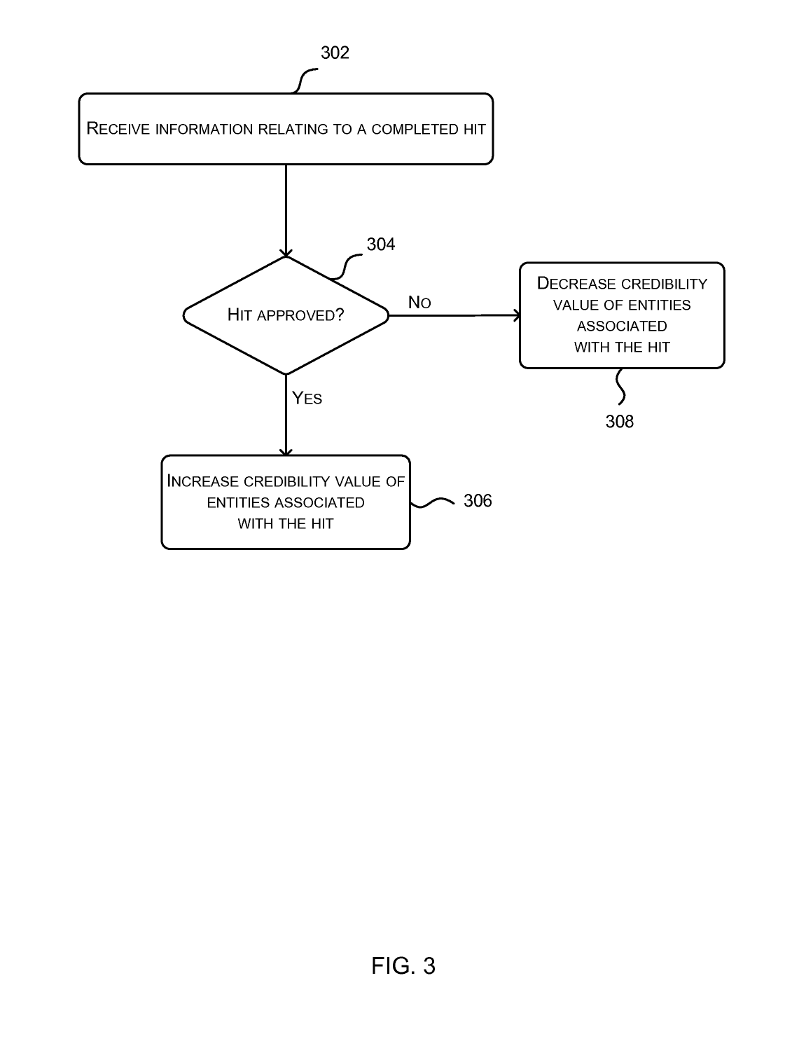

The operation of the system 100 and in particular the management entity 102 can be described in more detail with reference to FIGS. 2 and 3. FIG. 2 is a schematic diagram of the management entity 102 and FIG. 3 is a flow diagram of an example method of operation of the management entity 102. The system 100 operates based on a global currency which may be referred to as ‘credibility’ or credibility values or scores. The term ‘global’ is used in this context to refer to the fact that all buyers 106 and sellers 108 in the system have a credibility value and these values are managed (e.g. updated and, in many examples, stored) by the management entity 102. In some examples, the crowdsourcing platform 104 may also have a credibility value.

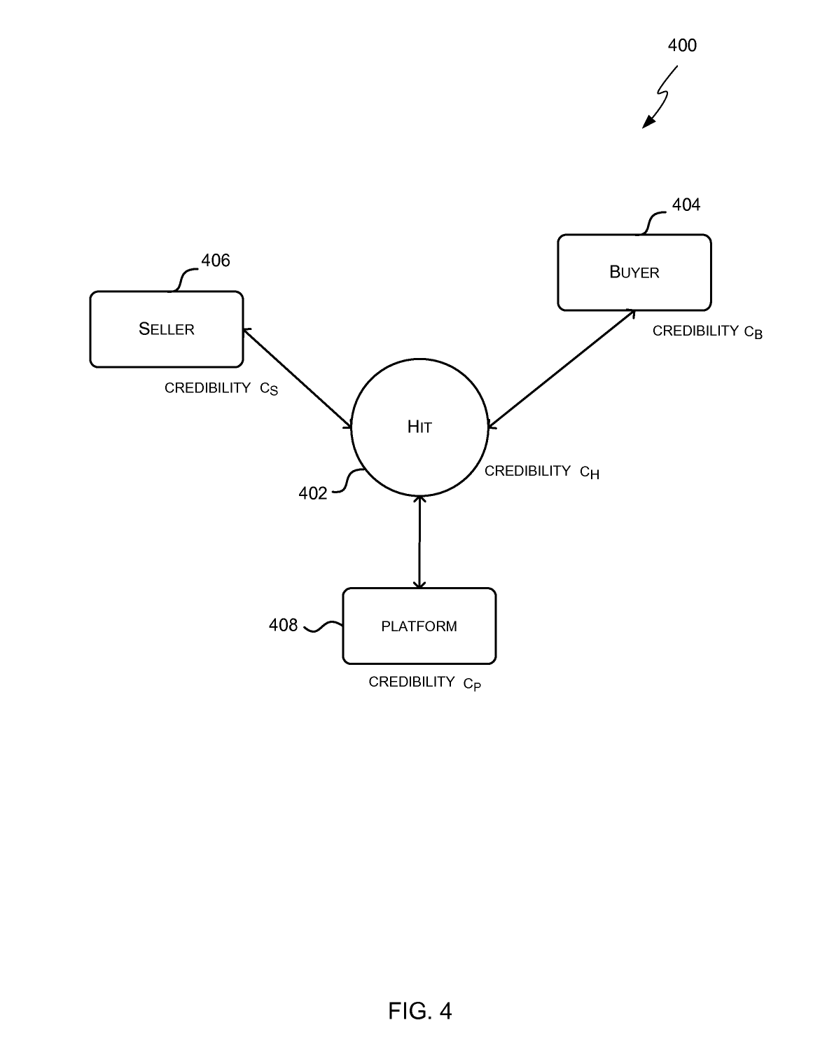

Within the system 100, buyers 106 publish HITs and sellers 108 accept and complete HITs. As described in more detail below, credibility is gained and lost as a function of the quantity and quality of work performed within the system. All credibility information is disclosed openly in the market place, similar to employment history for both workers and requesters. Credibility score is propagated along the edges of a network that is formed via interactions associated with the HITs (e.g. as shown in FIG. 4 which is described below). For example, a HIT published by a buyer and completed by a seller on a given platform connects all these three entities and credibility score is propagated in all directions. A seller's credibility is influenced by the credibility of the buyer that the seller worked for (i.e. sold human intelligence to) and the credibility of the platform itself. At the same time, the buyer's credibility is also updated as a result of the recent interaction with the seller and the platform. This means that a buyer's credibility is affected by the credibility of the hired workers.

Where a buyer is an agent or group of requesters, the credibility value of the buyer is a function of the credibility scores of its requesters. Similarly, where a seller is an agent or group of workers, the credibility value of the seller is a function of the credibility scores of its workers. An individual worker's credibility is a function of their work quality (i.e. approved HITs) and their network, i.e. the more credible sellers and buyers they worked for/with, the higher the worker's credibility.

In examples where the crowdsourcing platform has a credibility value, the credibility value (or score) of a crowdsourcing platform is the function of its sellers and buyers' credibility. This way, the platform's wealth in terms of credibility reflects the “economic status” of a given place of work in the system.

Within the system 100, the buyers 106 and sellers 108 may communicate with the crowdsourcing platform 104 directly and/or may communicate with the platform 104 via the management entity 102. A buyer 106 may provide information relating to HITs they want completed to either the management entity 102 or the platform 104. This information may comprise the buyer's details, the HIT template and data and, where workers will be paid, funds for payment of the worker if the HIT is approved. These HITs are then hosted by the crowdsourcing platform 104 and advertised by the platform and/or the management entity to enable sellers 108 to select and complete HITs. Once a HIT (or batch of HITs) is completed, the results are reviewed by the buyer who approves or rejects each HIT assignment in the batch. If a HIT is approved, the seller receives any payment which is due.

The management entity 102 comprises a data store 202 which is arranged to store a credibility value for each buyer 106 and seller 108 in the system 100 and an update engine 204 which is arranged to update the stored credibility values for buyers and sellers based on completed (and reviewed) HITs. Data relating to the buyers, sellers and completed HITs is received via an input 206 and this information may (depending upon implementation and the type of information) be received from buyers 106, sellers 108 and/or the crowdsourcing platform 104.

As shown in FIG. 3, on receipt of information relating to a completed HIT (block 302), the credibility update engine 204 increases the credibility values for all entities associated with the HIT (block 306) whose HIT assignments were approved by the buyer (‘Yes’ in block 304). For HIT assignments that were rejected by the buyer (‘No’ in block 304), the credibility values for all entities associated with those HIT assignments are decreased (block 308). The entities associated with a HIT include the buyer and the seller and may comprise additional entities, such as the platform (both in the case of single or multi-platform systems). An example network 400 for a HIT 402 is shown in FIG. 4. The network 400 connects the buyer 404 (that published the HIT), the seller 406 (that completed the HIT) and the platform 408 (that hosted the HIT) via the HIT 402.

Where the seller is an agent or group of workers, the entities associated with a HIT include the worker(s) that completed the HIT for the agent. Similarly, where the buyer is an agent or group of requesters, the entities associated with a HIT include the requester(s) that completed the HIT for the agent. Any suitable method may be used to update the credibility values (in blocks 306 and 308) and one example is described in detail below. In another example, Bayesian networks may be used, where the credibility values may be updated in the network after every new observation or every new set of observations.

As a consequence of this updating mechanism for credibility values which is implemented by the credibility update engine 204, the credibility value for an entity (buyer/seller/platform) summarizes the entity's past behavior and experience within the crowdsourcing system 100.

The method shown in FIG. 3 may be implemented each time a HIT is approved or rejected or with every HIT batch approval and rejection (i.e. once the batch is completed and all or some HIT assignments in the batch have been either approved or rejected by the buyer).

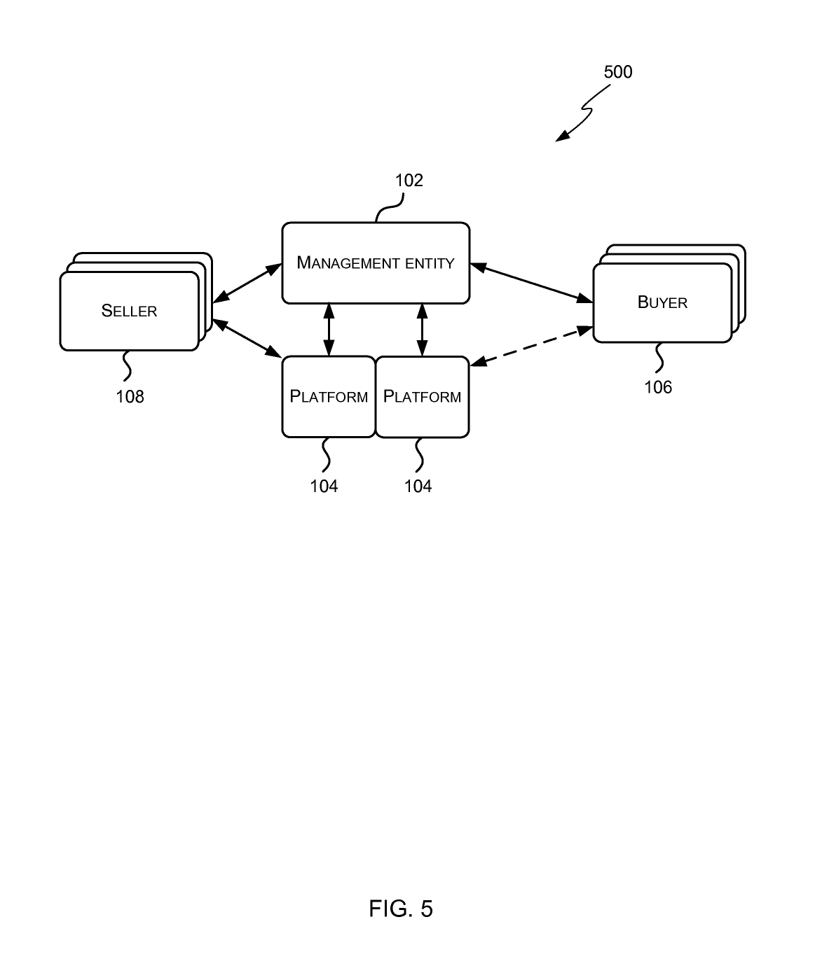

FIG. 5 is a schematic diagram of another crowdsourcing system 500 which comprises a management entity 102 that acts as an information broker among components of the system 500. In the example crowdsourcing system 500, there are multiple crowdsourcing platforms 104 which are connected by the management entity 102. Although the sellers 108 may interact with the management entity 102 directly or with the individual platforms 104, in the simplest implementations all buyers 106 interact directly with the management entity 102 in order to publish HITs. In some implementations, buyers 106 may perform operations directly with a platform 104 (as indicated by the dotted arrow in FIG. 5); however, information on these operations is still passed to the management entity 102, either by the buyer 106 (e.g. when they log on subsequently) or by the platform 104 that they interacted with. Identifiers associated with the buyers 106 (either generated by the management entity 102 or obtained by the management entity 102 from the platform 104) may then be used by the management entity 102 to obtain data from the various platforms 104 (e.g. data relating to completed HITs).

The operation of the management entity 102 in the system 500 of FIG. 5 is as described above (e.g. with reference to FIGS. 2 and 3). In updating credibility in the system 500, the credibility of the platforms 104 is also tracked and updated.

By having a management entity 102 which acts as a broker between multiple crowdsourcing platforms 104, as shown in FIG. 5, a buyer can create diverse HITs that cut across different crowdsourcing platforms (e.g. where different platforms have different specialties in relation to the tasks that can be performed on the platform). These diverse HITs may be referred to as ‘MegaHITs’.

Although FIGS. 1 and 5 show the management entity 102 (or market layer) as an independent layer (e.g. an independent meta-layer), it will be appreciated that in some examples the components of the management entity 102 may be integrated within a given crowdsourcing platform (e.g. where the management entity 102 controls a single platform 104). Where the management entity 102 is implemented as an independent layer, a push model or a pull model may be used for the interaction between the management entity 102 and the platform(s) 104.

In pull mode, there is cooperation between the management entity 102 and the platform(s) 104 such that the HIT data (i.e. information about the HITs, such as task description, pay, acceptance criteria, etc) from a platform 104 is made available to the management entity 102. The management entity 102 in turn makes the credibility values (or scores) available to the platform(s).

In push mode, the buyers interact with the management entity 102 directly. Sellers can interact with the management entity 102 or directly with a platform 104. The management entity 102 may create auto-IDs for anonymous workers who interact directly with a platform and consequently have not registered with the management entity 102 (and therefore do not have a seller ID allocated by the management entity). This means that these workers will still have profiles in the management entity 102, associated with their platform-specific worker ID, and will have a credibility value which is updated based only on HIT data for the particular platform to which the ID relates. Workers who engage with multiple platforms directly will have multiple (independent) personas in the management entity 102 and hence multiple (independent) credibility values. As anonymity is preserved, the management entity 102 will not know which personas relate to the same person and which persona(s) match any specified individual.

Where a buyer or seller registers with the management entity 102, registration data is stored inside the management entity 102. The management entity 102 then interacts with a given platform using the specific user's information to register the worker or requester. In the case of a worker who registers once with the management entity 102, they will have a single persona within the management entity 102 and their credibility value may be based on activity within any of the crowdsourcing platforms 104.

Jobs posted by a buyer through the management entity 102 are published on a given platform or multiple platforms using the data and funds provided by the buyer (buyer's details, HIT template and data, funds).

The management entity 102 accesses all the available jobs from all the platforms and provides functionality to enable sellers to find, recommend, or refer HITs. Once a seller finds a job that they wish to complete, they are taken to the platform that is hosting the HIT and they complete them on the hosting platform. Alternatively, as described above, a seller may find HITs directly on an individual crowdsourcing platform that hosts the HITs.

The management entity 102 downloads the HIT batch data from the platform using the buyer's identity (e.g. a buyer ID as generated by the management entity 102 when the buyer registers with the management entity). This HIT batch data is then available to the buyer who can approve or reject the HITs in the batch and the management entity 102 will then update the credibility values for all the entities associated with the HIT.

Where there are multiple crowdsourcing platforms (e.g. as in FIG. 5), the funds from the buyers may be coordinated by the management entity 102. Funds may be transferred from the buyer to the management entity when the HIT is published or subsequently (e.g. when a HIT is completed) and then when a HIT is accepted money is paid to the hosting platform and any remaining funds are paid back to the buyer (e.g. funds associated with those HITs within a batch that have been rejected). The hosting platform passes on money to the seller and may keep a part of the money. Similarly, the management entity may keep part of the monetary reward that a buyer offers for a HIT (e.g. where the management entity is operated separately from the crowdsourcing platforms).

Buyers may specify which sellers can access a job, e.g. sellers with minimum credibility score globally or in a given set of skills, specifically identified sellers, etc. These can be implemented as qualification tests on the platform side. If there is a restriction on the HIT batch to specific sellers, then only workers with an identity in the management entity can access the tasks (i.e. those workers who have registered with the management entity). Although this enables buyers to target specific sellers for performance of HITs, anonymity is still preserved as sellers may be identified based on their seller ID as allocated by the management entity 102 and not based on any personally identifiable data. A user may have one or more seller IDs (e.g. if they register separately with different platforms and/or register more than once with the management entity 102) and the buyers 106 will not know if multiple seller IDs relate to a single worker (i.e. a single human user).

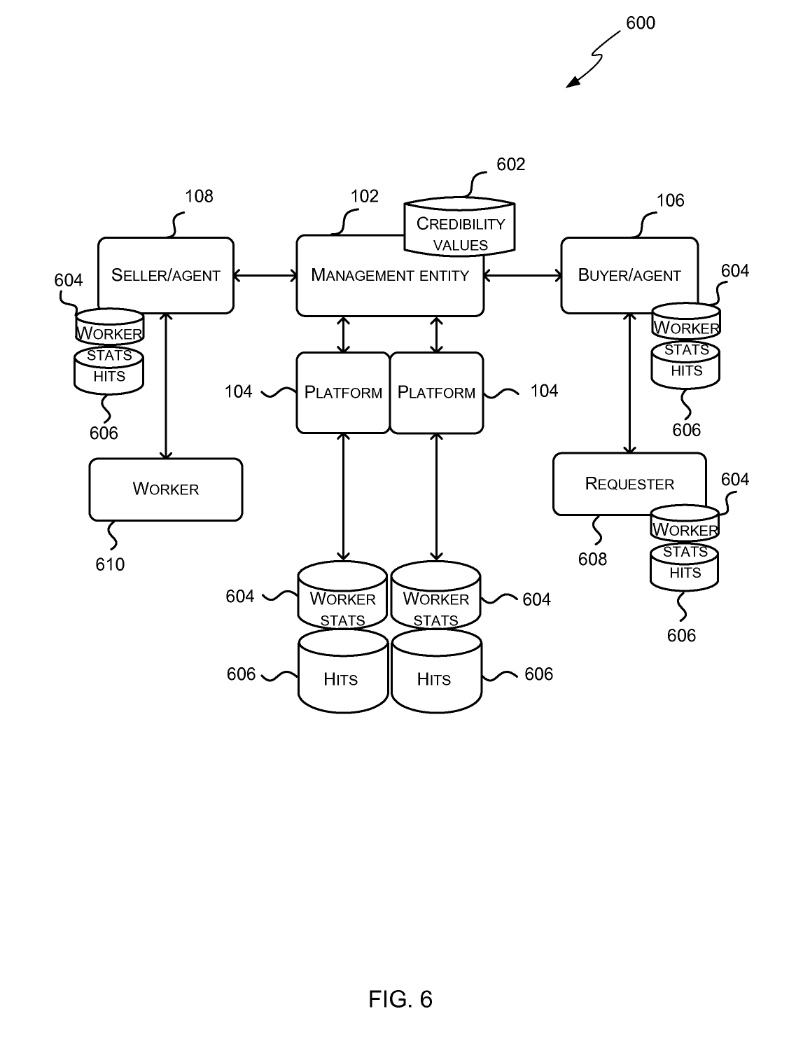

FIG. 6 is a schematic diagram of a further example crowdsourcing system 600 which comprises a management entity 102 that acts as an information broker among components of the system 600. In this example crowdsourcing system 600, there are multiple crowdsourcing platforms 104 which are connected by the management entity 102. In this example, the credibility values are still managed by the management entity 102 and may be stored in data store 602. Credibility values for workers may, in addition, be stored in a distributed manner in one or more data stores 604 managed by the platforms as is the HIT data (in data stores 606). As shown in this example, a buyer 106 may be a requester itself or may act as an agent and register a requester 608 with the management entity 102. The buyer 106 which is acting as an agent may also collect funds from the requesters 608 that they represent and pass these on to the management entity 102. Similarly, a seller 108 may be a seller itself or may act as an agent and register a worker 610 with the management entity 102. The seller 108 which is acting as an agent may also distribute pay to any workers 610 that they represent.

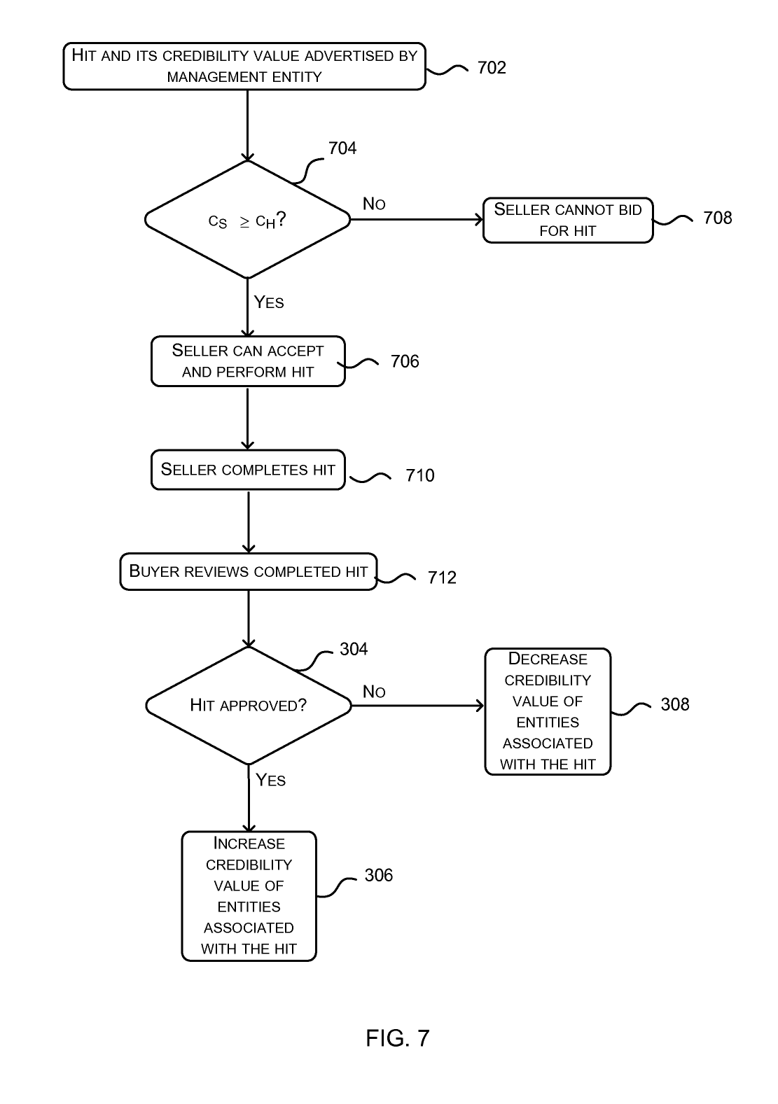

In any of the systems 100, 500, 600 described above, the credibility values associated with a seller may affect the amount of work that the seller can agree to perform, as shown in the example flow diagram in FIG. 7. In this example, when a HIT is published and advertised to sellers, the credibility value of the HIT, c_{H}, is also advertised (block 702). A seller can only accept and perform the HIT (block 706), if the seller's credibility value, c_{S}, equals or exceeds the credibility value of the HIT, c_{H} (‘Yes’ in block 704). Where the seller's credibility is too low (‘No’ in block 704), the seller cannot accept and perform the HIT (block 708). Once a seller has accepted the HIT, the method then proceeds as described above with the seller completing the HIT (block 710), the buyer reviewing the completed HIT (block 712) and depending upon whether the HIT is approved or not, the credibility values of all associated entities are updated (in block 306 or 308).

In an example, an activity management engine 208 (as shown in FIG. 2) within the management entity 102 may implement the activity management elements of FIG. 7 (e.g. blocks 704-708) and the credibility update engine 204 may implement the update elements of FIG. 7 (e.g. blocks 304-308). The generation of the credibility value of a HIT (which is advertised in block 702) may be performed by the credibility update engine 204 or by a separate engine (not shown in FIG. 2).

Using the mechanism shown in FIG. 7, sellers bid for HITs by implicitly staking a percentage of their credibility value, equal to the credibility value of the HIT and this staked portion of their credibility value is lost if the HIT is not completed satisfactorily (i.e. if the HIT is completed and rejected). This prevents sellers from accepting lots of work that they may not be able to complete (such sellers may be referred to as ‘spam sellers’). An experienced and trusted seller will have a higher credibility value than a less experienced and less trusted seller and will therefore be able to accept more HITs.

It will be appreciated that, although the example of FIG. 7 shows that a seller can only accept a HIT if c_{S}≧c_{H} (as evaluated in block 704), in other examples a different test may be used to determine whether a seller may accept a hit (e.g. if c_{H}/c_{S}≧T, where T is a threshold value or based on any function of c_{S}). Buyers may also set criteria of requiring a minimum credibility value in a specific skill set.

FIG. 7 shows an example method in which the activity of sellers is affected by their credibility value. In some examples, the activity of buyers may, in addition or instead, be affected by the buyer's credibility scores. In such an example, a buyer may be limited in the amount of HITs they can publish based on the credibility values of the HITs (e.g. the sum of credibility values of all published HITs, Σc_{H}) as a function of their credibility value, c_{B}. Such a mechanism has the effect that crowdsourcing platforms are improved by rejecting those buyers who publish mostly unsuccessful jobs, attract mostly bad workers, or reject most work (and hence have a low credibility value). The control of activity of any entity within the system (e.g. seller/buyer) may be implemented by the activity management engine 208.

In some implementations, buyers and sellers may be issued with a starting credibility value (which is non-zero) when they register with the management entity 102 (either directly or via a crowdsourcing platform). This means that where the credibility value limits the activity of a buyer/seller, they have a minimum activity level that they are permitted initially, before they increase their credibility value through publishing/completing HITs. There may be a mechanism within the management entity 102 to reset a credibility value to this minimum level subsequently (e.g. if there is an issue with a buyer/seller's performance or behavior within the crowdsourcing system). The minimum value may also be defined and updated as a function of past average performance over all buyers/sellers in a system. In some implementations, other sellers or buyers may ‘vouch’ for new sellers or buyers and stake their own credibility value when publishing or bidding for HITs. More generally, sellers and buyers may stake their own credibility on behalf of others (whether new to the system or not) when publishing of bidding for HITs (e.g. via referral or another mechanism) and they may also pool their credibility.

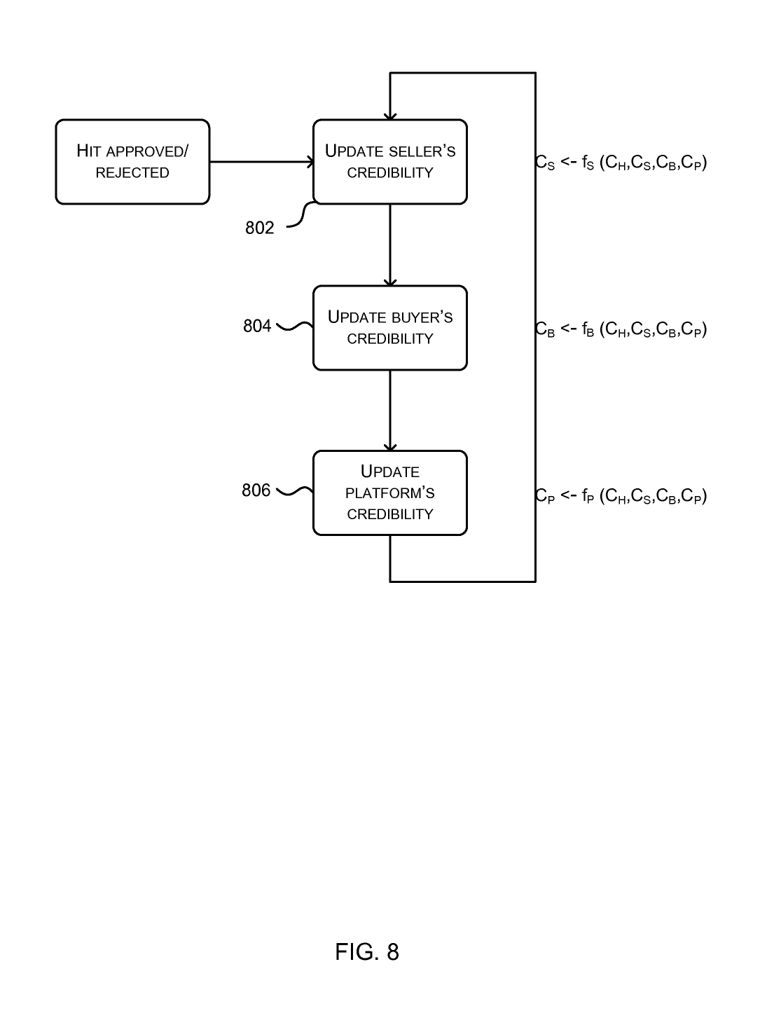

As described above, any suitable mechanism may be used to update credibility values when a HIT or batch of HITs is approved or rejected and one example method may be described with reference to FIGS. 4 and 8. The credibility of workers/sellers 406, who were directly associated with the HIT 402 is updated in the first step (block 802). This is followed by updates to the buyers' scores (block 804). The buyers' updated scores impact on all associated sellers' scores through the propagation process (which may occur straight away or when the next HIT is evaluated). Finally the platform's credibility is updated (block 806), which is then propagated to all related buyers and sellers either straight away or when the next HIT is evaluated. Through the network shown in FIG. 4 and the mechanism shown in FIG. 8, there is an inherent linking of credibility values between parties within the crowdsourcing system 100, 500, 600.

A HIT's credibility value that will be propagated in the network may, for example, be specified as a number in the range of [0,1] and be a function of three variables:

the calculated or estimated difficulty level of the HIT, c_{diff},

the credibility of the buyer, c_{B}, and

the credibility of the platform, cₚ.

In some examples, there may be a fourth variable which relates to whether the HIT was referred by another entity (e.g. another seller). It will be appreciated that in other examples, any subset of these variables may be used and there may be additional variables used. Depending on the binary decision whether a HIT assignment was approved or rejected by the buyer, c_{A/R}, which may have a value of either 1 or −1, the credibility value may be used to increase or decrease the credibility score of the sellers, buyers and platforms connected to the HIT.

The difficulty, c_{diff}ε[0,1], in its simplest form, may be calculated as:

$${c}_{diff} = 1 - \frac{\sum Approved HITS in batch}{( 1 + m ) \cdot \sum HITs in batch}$$

where m in [0,1] can be used to ensure a minimum credibility value (e.g. with m>0, easy HITs would get c_{diff}>0). When all HITs in a batch are approved it may be considered an easy HIT. The above equation requires that all HIT assignments in a HIT batch have been processed by the buyer. In some examples, it may be desirable to update the HIT credibility score as incoming assignments are approved or rejected. When none or not all of the HIT assignments in a HIT batch have been completed and approved or rejected, the difficulty may be estimated or learnt based on the buyer's average past approval rate globally or for similar tasks, based on a minimum (reserve) credibility value or by extrapolating based on the completed portion of the task and any combination of these factors. In the case when the credibility score of a HIT changes dynamically, this may impact sellers' abilities to bid on tasks as well as the reward/penalty a seller receives on completing the HIT. If the buyer incrementally approves/rejects HIT assignments as they get completed, the HIT may become easier or harder. The system may then propagate the at-the-time HIT credibility score to the sellers or may update the sellers' credibility only when the full batch has been completed. Alternatively, the difficulty scores may be defined independently from the approval rate, using an agreed difficulty scale by the management system.

Given the buyer's credibility value, c_{B}ε[0,1], and the platform's credibility value, cₚε[0,1], the credibility of a HIT may be a function such as

$${c}_{H} = \{ \begin{matrix}{c}_{diff} \cdot {log}_{2} ( {c}_{B} + 1 ) \cdot {log}_{2} ( {c}_{P} + 1 ) , & {c}_{A / R} > 0 \\ ( 1 - {c}_{diff} ) \cdot {log}_{2} ( {c}_{B} + 1 ) \cdot {log}_{2} ( {c}_{P} + 1 ) , & {c}_{A / R} < 0.\end{matrix}$$

This means that if a hard HIT is rejected, the penalty is small, while for easy rejected HITs, the penalty is large. On the other hand, for easy approved HITs the reward is small while for hard approved HITs the reward is large. The use of logarithms in this example, in relation to both a buyer credibility metric (based on c_{B}) and a platform credibility metric (based on cₚ), gives an uplift to HITs from buyers and platforms that have lower credibility values (e.g. because they are newer to the system). Alternatively many different functions may be used (based on the values c_{B} and cₚ) or the credibility values themselves may be used.

In addition to the credibility score for a HIT, the mechanism may consider the uncertainty associated with the score. This could, for example, be a function of the size of the HIT batch, e.g. 1/(ΣHITs in batch). For example, when only a few HITs are in the batch, the uncertainty of the calculated c_{H} score is high. Uncertainty may also consider the variance or entropy of possible c_{H} scores in the batch. It may also include the uncertainty of the buyer's credibility score. For example, when a buyer only has a small circle of sellers, the buyer's credibility is heavily dependent on those sellers' credibility. Vice versa, when a seller only works for one or very few buyers, the seller's credibility score may not be representative of the quality of their work for another buyer; thus their credibility score is uncertain to generalize to other situations. Since all information about the credibility score, its composition and history, is transparently disclosed in the market place, buyers and sellers can act on that information by themselves or via filtering algorithms implemented through the management entity.

When updating the credibility score of a seller (in block 802), the HIT's credibility score c_{H} is used to increase the seller's current credibility, c_{S}, such that the new value remains in [0,1] and may in some examples use a time decay function, so that the previous score's influence is reduced. This is so that, for example, an unlucky batch of work does not permanently ruin a seller's credibility, or a previously good worker cannot become lazy without affecting their credibility. An example update method is:

c_{S}=(α·c_{S}+β·c_{H})/(α+β)

which uses a weighted sum of both the current credibility value of the seller (prior to the update) and the credibility value of the recent HIT. In this example, α and β may be time decay factors, both in [0,1]. They also may control the propagation of the HIT scores when a HIT was referred, reducing the penalty/reward for a HIT on the seller who referred the HIT. This is so that the referrer can take a share of the responsibility (loss or gain of credibility) of a referred HIT, where the portion of the share may be a result of negotiations between the referrer and the referred sellers. These factors may also reflect uncertainty, i.e. the impact of the update score can be reduced when uncertainty is high.

Having updated the seller's credibility values (in block 802) as described above, the buyers' and platforms' scores are then recalculated (in blocks 804 and 806) as an aggregate of all the associated sellers' scores connected to them in the network. For example, all buyers that are connected to the seller(s) updated in block 802 may be updated (in block 804) using:

$${c}_{B} = {f}_{B} ( {\sum }_{{connected}_{sellers}} {c}_{S} )$$

where f_{B} ( ) is any function of the variable within the brackets. Then all the platforms that any of the updated buyers and sellers are connected to may be updated (in block 806) using:

$${c}_{P} = {f}_{P} ( {\sum }_{\begin{matrix}connected \\ sellers\end{matrix}} {c}_{S} , {\sum }_{\begin{matrix}connected \\ buyers\end{matrix}} {c}_{B} )$$

where fₚ ( ) is any function of the variables within the brackets.

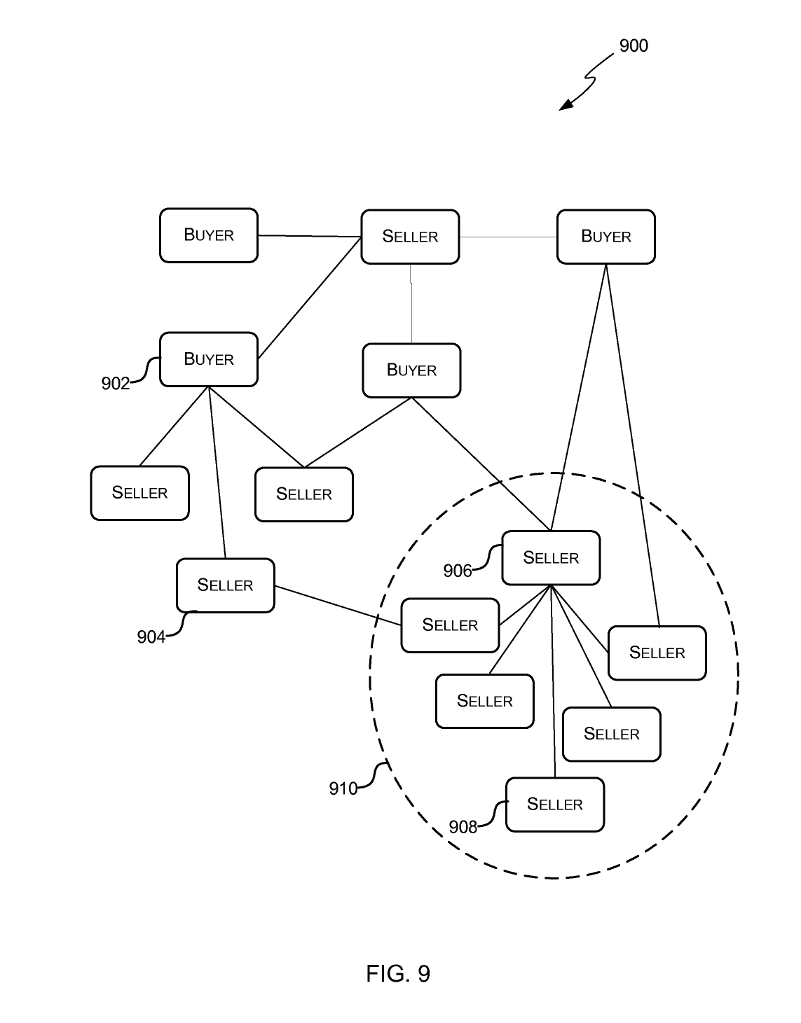

Alternative to specifying the exact formulas for the computation of credibility score, one can apply methods that derive credibility scores from the statistical distribution of factors that characterize the interaction within the system, such as the approval and rejection of HITs, approval and rejection of bids for HITs and similar. One such method is a use of a Bayesian network, represented through graphical models and applying message propagation algorithms to arrive at the credibility scores and their confidence levels. In either case, all the above credibility values can be calculated globally such that an entity has a single credibility value or, in addition (or instead), the credibility values may be broken down per task type or task domain. Where credibility values are broken down in this way, an entity may, for example, have a separate credibility score for categorization tasks versus spelling correction tasks and/or video versus textual tasks, etc. The categorization of credibility values may, for example, be based on a taxonomy or uncontrolled vocabulary derived by clustering or another IR technique. Use of such categorized credibility tasks enables the credibility values to reflect different abilities of an entity in different types of work and enables a worker to develop career paths in multiple fields of tasks (e.g. a worker may strive to have high credibility values in several different types of tasks) and a buyer to target workers who have relevant credibility for the particular HIT being published (rather than just general credibility). As an alternative to dividing a workers credibility values between different categories of work, a worker may use separate independent personas for different types of work; however, use of a single persona enables the management entity to produce a more complete social graph of those in the crowd. An example of such a graph or network is shown in FIG. 9 and described below.

Within a crowdsourcing system, such as those shown in FIGS. 1, 5 and 6, there may be recommendation and/or referral mechanisms which may be implemented and/or tracked by the management entity 102. The difference between these mechanisms may be described with reference to an example in which there is seller X. Seller X comes across a batch of HITs on the market and wants to recommend or refer these to a friend, Y, instead of completing the HITs themselves. Recommendation is a referral with no shared responsibilities or gains: X simply points Y to the HITs through any communication channel, (e.g. email, Facebook, Twitter, text message, crowdsourcing platform 104 or system 100 provided communication channels, etc.). HITs in this case are not blocked on the platform, which means that the HIT is still available for another seller to accept and complete. In contrast, with referral there is some sharing of the responsibilities or gains and referral may be at different levels.

The basic referral is where a share of the credibility value that may be gained (or lost) with the HITs is allocated to the referrer instead of it all being allocated to the worker that completes the task. In this way the referrer shares in the reward and the responsibility of completing the HIT. The referrer (or the management entity or platform) can specify their cut of the possible gains/losses (i.e. this is their own risk) or X and Y can negotiate this. In either case, Y can accept and do the HIT or reject or ignore the referral. If Y completes the HIT, both X and Y have their credibility values updated and dependent upon the methods used for updating and propagating credibility values within the system, if the HIT is approved by the buyer, both X and Y may get an increase in their credibility values; however, if the HIT is rejected, they may both have their credibility values reduced.

At another level, the referral may involve sharing any monetary reward that is paid for accepted HITs (in addition to sharing in the update of credibility values, as described above). Any fees which are paid to the referrer (rather than the worker that actually completed the HIT) are deducted from the pay of the worker. In this case the management entity 102 which facilities the referral communicates with the platform to ensure that the funds are distributed accordingly.

In all cases of referral, the management entity 102 tracks the referral such that both the referrer and the worker that completes the HIT have their credibility values updated upon completion of the HIT (e.g. in block 802).

Where a HIT is referred (at either level), the referred HIT may be considered by the system to be “in progress” and blocked from other workers for a limited period of time (e.g. one hour) on the hosting platform. This prevents the worker to whom the HIT is referred from accepting the HIT directly and bypassing the referrer. The worker who receives the referral then has the limited period of time (e.g. the one hour in the previous example) to complete the HIT or it will re-enter the pool of available HITs and is open to be completed by other workers.

A referring seller may refer the same HIT to a single worker or to multiple workers and where the HIT is referred to multiple workers, the workers may or may not be made aware of the competition. If multiple workers are used, the referring seller may set the conditions so that either only the first worker to complete the HIT is paid, or that all workers are paid, or that a certain number of them are paid, for example, the first three workers with the same answer. The referring seller may manage the pay by splitting the original reward or by investing his/her own money. This investment may be beneficial for them when they build their network, for example, or in aid of establishing trusted relationship with the buyer.

Any suitable communication method may be used to perform the referral and the referral may be a URL with parameter values for controlling the engagement of the recipient worker. The URL and message (e.g. email, SMS, IM or Facebook message) may be generated by the management entity 102 which manages the referral process and if necessary, a worker login (e.g. a worker ID) may be automatically generated (i.e. where the recipient worker has not already registered with the management entity and therefore does not already have an ID for the management entity).

As described above, in some examples, the activity of a buyer to publish HITs or the activity of a seller to perform HITs may be limited based on their current credibility values. Similarly, in some examples, the credibility value of a seller may be used to limit the number of referrals they can make. Sellers can choose to refer a single HIT or a batch of HITs to a single person or to a set of people. Since each referral is a potential source of credibility score (and in some cases money), they are incentivized to refer jobs to those who are more likely to complete them well. Referring HITs to those who then ignore the referral will lose them the potential to earn while also tying down a portion of their credibility score for the amount of time the HITs are blocked.

Use of referral within a crowdsourcing system such as shown in FIGS. 1, 5 and 6 improves the overall work quality by allowing sellers to refer a task to someone who is more qualified to complete it. As referring sellers share in the reward, they are motivated to familiarize themselves with the task and refer it to an appropriate worker. Whilst workers are anonymous within the system, a referrer will know the people who they are referring work to personally or by researching the credibility scores of workers in the market place. The workers that receive referrals receive information about HITs that are likely to be appropriate to their skill set and do not have to spend time searching for suitable HITs to complete and this results in a strengthening of the relationship between the referring seller and the worker completing the HIT.

The use of referral implicitly adds an element of quality control because the referrer is penalized (in terms of their credibility value) if the completed HIT is rejected, as described above. In some examples, there may also be an explicit element of quality control with the referring seller receiving the completed HIT for checking prior to it being sent to the buyer. Where the referrer considers that the HIT has not been satisfactorily completed, a mechanism may be provided by which the referrer can refer the HIT onto another worker and reject the work product of the original worker that completed the HIT.

Through the methods described above, and in particular the networks (e.g. as shown in FIG. 4) which are established for each completed HIT, the management entity 102 may compile an overall network of connections within the crowdsourcing system, as shown in FIG. 9. Data relating to this network 900 (or social graph) may be stored in data store 202. This overall network 900 connects buyers 902 to sellers 904 that have completed their HITs and referring sellers 906 to the workers 908 that completed the referred HITs. Within this overall network 900, social groups (e.g. as indicated by dotted circle 910) will be visible (e.g. groups of workers that regularly refer work to each other or workers who regularly work with specific buyers, etc.) and this information may be used to reduce the risk of cheating/collusion (e.g. where the same HIT is referred to the same workers more than once), even where users have multiple IDs within the system. In an example, the management entity 102 may limit HIT distribution so that once a worker in a connected group of workers 910 has completed an instance of a HIT, then another worker from the same group cannot.

In some examples of the crowdsourcing systems described above, a requester may be enabled, via the management entity 102, to auction HITs to the crowd in general or to the network of referring sellers. The management of the auction process may be through the management entity 102 which may again use the overall network 900 it is aware of to ensure that the auction is not affected by workers collaborating to increase the price that the buyer must ultimately pay the seller for completion of the HIT (or bundle of HITs). In some cases, groups of sellers may pool their credibility scores to bid for HITs.

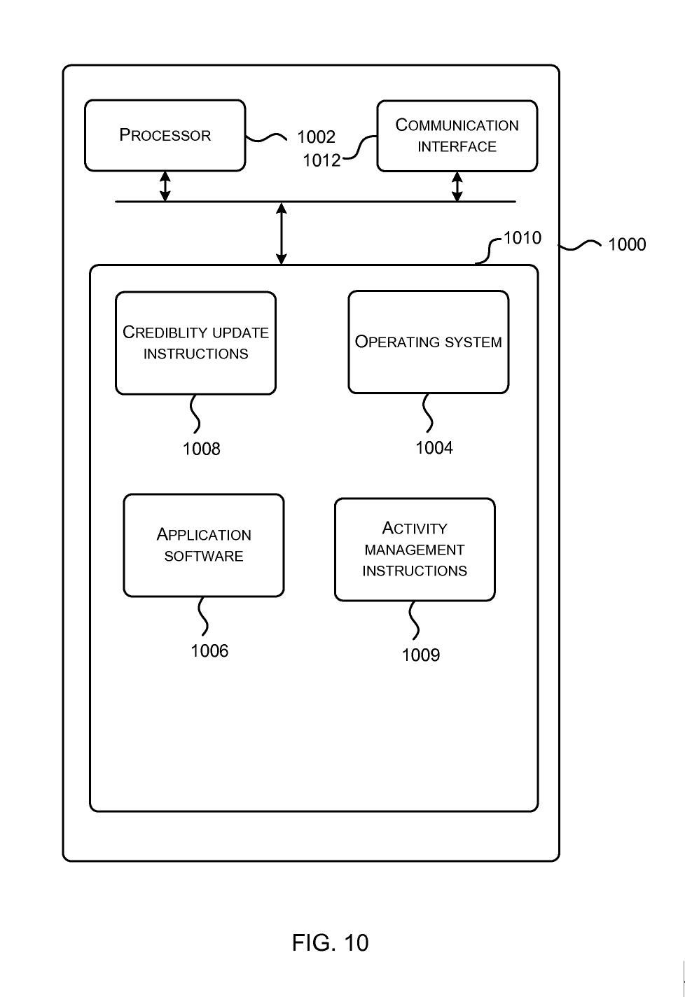

FIG. 10 illustrates various components of an exemplary computing-based device 1000 which may be implemented as any form of a computing and/or electronic device, and in which embodiments of the management entity 102 may be implemented.

Computing-based device 1000 comprises one or more processors 1002 which may be microprocessors, controllers or any other suitable type of processors for processing computer executable instructions to control the operation of the device in order to implement the functionality of the management entity 102. In some examples, for example where a system on a chip architecture is used, the processors 1002 may include one or more fixed function blocks (also referred to as accelerators) which implement a part of the method of operation of the management entity 102 in hardware (rather than software or firmware). Platform software comprising an operating system 1004 or any other suitable platform software may be provided at the computing-based device to enable application software 1006 to be executed on the device. This application software 1006 may, for example, comprise computer executable instructions 1008 which implement the credibility update engine 204 (described above) and computer executable instructions 1009 which implement the activity management engine 208 (described above).

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), Graphics Processing Units (GPUs).

The computer executable instructions may be provided using any computer-readable media that is accessible by computing based device 1000. Computer-readable media may include, for example, computer storage media such as memory 1010 and communications media. Computer storage media, such as memory 1010, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 1010) is shown within the computing-based device 1000 it will be appreciated that the storage may be distributed or located remotely and accessed via a network or other communication link (e.g. using communication interface 1012).

The memory 1010 may further be used to provide the data store 202 described above which stores the credibility values for entities within the crowdsourcing system. The communication interface 1012 may further provide the input 206 described above and which receives information about completed HITs.

The credibility values which provide a global currency and the associated update mechanism (provided by the management entity) described above may have the effect of aligning the incentives for both the buyers and the sellers within a crowdsourcing system. This therefore may reduce contention between motivations which existing in current crowdsourcing platforms. For example, the reward for a worker is higher for harder tasks and a limit may be imposed on the number of tasks a worker can accept at any time. If a seller performs badly, their credibility value is reduced and this reduces their ability to get work. If a buyer performs badly, for example by attracting bad workers, the buyer's credibility value is reduced and the buyers may ultimately be pushed out of the system.

Where there are multiple crowdsourcing platforms within a system (as shown in FIGS. 5 and 6), the credibility value is a unifying currency across platforms. Where the credibility value of a HIT is dependent upon the credibility value of the hosting platform (as in the example described above), buyers and sellers are incentivized to use platforms with a higher credibility value.

In the example crowdsourcing systems shown in FIGS. 1, 5 and 6 there is a single management entity (or market) 102. In a further variation there may be multiple management entities in a system, or multiple co-operating systems each comprising a single management entity, and these management entities 102 may exchange information such as credibility scores.

The methods described above do not differentiate between workers and their agents (all are considered sellers). When updating credibility values, anyone involved in completing the HIT has their credibility value updated to some degree proportional to their share of responsibility or risk taken.

Although the present examples are described and illustrated herein as being implemented in a crowdsourcing system, the system described is provided as an example and not a limitation. As those skilled in the art will appreciate, the present examples are suitable for application in a variety of different types of systems which use an anonymous workforce and where there is no contract between the workers and those providing the work (who may be considered the employers).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc. and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A management entity for a crowdsourcing system comprising:
an input for receiving data relating to sellers, buyers and HITs in one or more crowdsourcing platforms;
a data store arranged to store a credibility value for each seller and each buyer in the system; and
a credibility update engine arranged to update the stored credibility values for any buyers and sellers associated with a HIT once the HIT has been completed and reviewed.

2. A management entity according to claim 1, wherein the credibility update engine is arranged to increase the stored credibility values for any buyers and sellers associated with a HIT that has been completed and accepted and to decrease the stored credibility values for any buyers and sellers associated with a HIT that has been completed and rejected.

3. A management entity according to claim 1, wherein the credibility update engine is arranged to update the stored credibility values for any buyers and sellers associated with a HIT once the HIT has been completed and reviewed based on at least one of: whether the HIT was approved or rejected, a difficulty level of the HIT, the stored credibility value for the buyer who published the HIT and a stored credibility value for the crowdsourcing platform hosting the HIT.

4. A management entity according to claim 3, wherein the credibility update engine is further arranged to update the stored credibility values for any sellers associated with a HIT based on whether the seller completed the HIT or referred the HIT to another seller.

5. A management entity according to claim 1, wherein the crowdsourcing system comprises a plurality of crowdsourcing platforms and the data store is further arranged to store a credibility value for each crowdsourcing platform.

6. A management entity according to claim 5, wherein the credibility update engine arranged to update the stored credibility values by updating the stored credibility values for any sellers associated with the HIT, updating the stored credibility values for any buyers connected to a seller associated with the HIT and updating the stored credibility values for any platforms connected to a buyer or seller with an updated stored credibility value.

7. A management entity according to claim 1, wherein the data store is arranged to store one or more credibility values for each seller and each buyer in the system and wherein different credibility values for the same seller or buyer relate to different types of HITs.

8. A management entity according to claim 1, further comprising an activity management entity arranged to control activity of a buyer or a seller according to the stored credibility value for the buyer or seller.

9. A management entity according to claim 8, wherein the activity management engine is arranged to control activity or buyer or a seller based on the stored credibility value for the buyer or seller and a credibility value for one or more HITs.

10. A management entity according to claim 9, wherein the credibility value for a HIT is calculated based on at least one of: whether the HIT was approved or rejected, a difficulty level of the HIT, the stored credibility value for the buyer who published the HIT and a stored credibility value for the crowdsourcing platform hosting the HIT.

11. A method of controlling a crowdsourcing system, the system comprising one or more crowdsourcing platforms and a plurality of buyers and sellers, the method comprising:
receiving, at a management entity, information relating to a completed HIT, the information identifying whether the HIT was approved or rejected; and
updating a stored credibility value for each buyer and seller associated with the HIT,
wherein if the HIT was approved, the updating increases the stored credibility value and if the HIT was rejected, the updating decreases the stored credibility value.

12. A method according to claim 11, wherein the updating of a stored credibility value is based on at least one of: whether the HIT was approved or rejected, a difficulty level of the HIT, the stored credibility value for the buyer who published the HIT and a stored credibility value for the crowdsourcing platform hosting the HIT.

13. A method according to claim 12, wherein the updating of a stored credibility value for a seller is further based on whether the seller completed the HIT or referred the HIT to another seller.

14. A method according to claim 12, wherein the updating of a stored credibility value for a buyer or seller is further based on a time decay function.

15. A method according to claim 11, wherein the stored credibility value for a buyer or seller is selected for updating based on a categorization of the completed HIT.

16. A method according to claim 11, wherein the system comprises a plurality of crowdsourcing platforms and updating a stored credibility value for each buyer and seller associated with the HIT comprises:
updating the stored credibility values for any sellers associated with the HIT;
updating the stored credibility values for any buyers connected to a seller associated with the HIT; and
updating the stored credibility values for any platforms connected to a buyer or seller with an updated stored credibility value.

17. A method according to claim 11, further comprising:
storing a credibility value for each seller and each buyer in the system.

18. A method according to claim 17, further comprising:
controlling activity of a buyer or seller based on the stored credibility value of the seller or buyer and a credibility value for one or more HITs.

19. A method according to claim 18, further comprising:
calculating a credibility value for a HIT based on at least one of: whether the HIT was approved or rejected, a difficulty level of the HIT, the stored credibility value for the buyer who published the HIT and a stored credibility value for the crowdsourcing platform hosting the HIT.

20. A management entity for a crowdsourcing system comprising:
an input for receiving data relating to sellers, buyers and HITs in a plurality of crowdsourcing platforms;
a data store arranged to store a credibility value for each seller, each buyer and each crowdsourcing platform in the system; and
a credibility update engine arranged to update the stored credibility values for any buyers, sellers and platforms associated with a HIT once the HIT has been completed and reviewed.
